(19) United States
(12) Patent Application Publication
(10) Pub. No.: US 2025/0118502 A1
(43) Pub. Date: Apr. 10, 2025

(54) Contact Bridge and Method for Manufacturing a Contact Bridge

(71) Applicant: TE Connectivity Austria GmbH, Waidhofen an der Thaya (AT)

(72) Inventors: Bernd Wesely, Waidhofen (AT); Markus Gutmann, Waidhofen an der Thaya (AT)

(73) Assignee: TE Connectivity Austria GmbH, Waidhofen an der Thaya (AT)

(21) Appl. No.: 18/910,539

(22) Filed: Oct. 9, 2024

(30) Foreign Application Priority Data
Oct. 9, 2023 (EP) 23202410.9

(51) Int. Cl. H01H 1/20; H01H 1/26; H01H 11/06

(52) U.S. Cl. CPC H01H 1/20; H01H 1/26; H01H 2011/062; H01H 2221/022

(57) ABSTRACT

An electrical contact bridge for an electromechanical device includes a bridge element and a spring element. The bridge element has a first contacting portion engaging a first electrical terminal of the electromechanical device, a second contacting portion engaging a second electrical terminal of the electromechanical device, and a middle portion between the first contacting portion and the second contacting portion. The spring element has a flat spring attached to the middle portion.

### CROSS-REFERENCE TO RELATED APPLICATIONS

This application claims the benefit of the filing date under 35 U.S.C. § 119 (a)-(d) of European Patent Application No. 23202410.9, filed on Oct. 9, 2023.

### FIELD OF THE INVENTION

The present invention relates to a contact bridge for an electromechanical device, in particular for a contactor. The invention also relates to a method for manufacturing the contact bridge, to a sub-assembly comprising the contact bridge, and to an electromechanical device comprising the sub-assembly.

### BACKGROUND OF THE INVENTION

Electromechanical devices are known that secure the opening and the closing of electrical circuits, for example a contactor, relay, switch or the like. In some such electromechanical devices, a first and a second terminal are separated by a gap. A movable part mechanically connected to an electrical contact bridge is provided moveably therein along a moving direction. Specifically, the movable part is movable between a closed state of an electrical circuit in which a bridge element of the contact bridge electrically bridges the gap, and an open state of the electrical circuit in which the gap is not electrically bridged.

It is further known to spring-load the bridge element of the electrical contact bridge against the movable part. The spring-loading absorbs overtravel or excessive force in the case of activation, which can prevent damage and ensure consistent contact force distribution over a plurality of contact bridges despite manufacturing tolerances. Typically, the overtravel spring is a helical coil spring attached at one end to a middle portion of the bridge element and at the other end to the movable part. However, helical coil springs are cumbersome to handle and to assemble in an electromechanical device, leading to additional manufacturing cost.

### SUMMARY OF THE INVENTION

An electrical contact bridge for an electromechanical device includes a bridge element and a spring element. The bridge element has a first contacting portion engaging a first electrical terminal of the electromechanical device, a second contacting portion engaging a second electrical terminal of the electromechanical device, and a middle portion between the first contacting portion and the second contacting portion. The spring element has a flat spring attached to the middle portion.

### BRIEF DESCRIPTION OF THE DRAWINGS

Aspects, objects, features and advantages of the present invention will be more completely understood and appreciated by careful study of the following more detailed description of exemplary embodiments of the invention, taken in conjunction with accompanying drawings, in which:

FIG. 1 illustrates an electrical contact bridge according to a first embodiment;

FIG. 2 illustrates an electrical contact bridge according to a second embodiment;

FIG. 3 illustrates a sub-assembly according to a third embodiment;

FIG. 4 shows a cross-sectional view of the sub-assembly of FIG. 3;

FIG. 5 illustrates an electro-mechanical device according to a fourth embodiment; and

FIG. 6 shows a flowchart of a method for manufacturing an electrical contact bridge.

### DETAILED DESCRIPTION

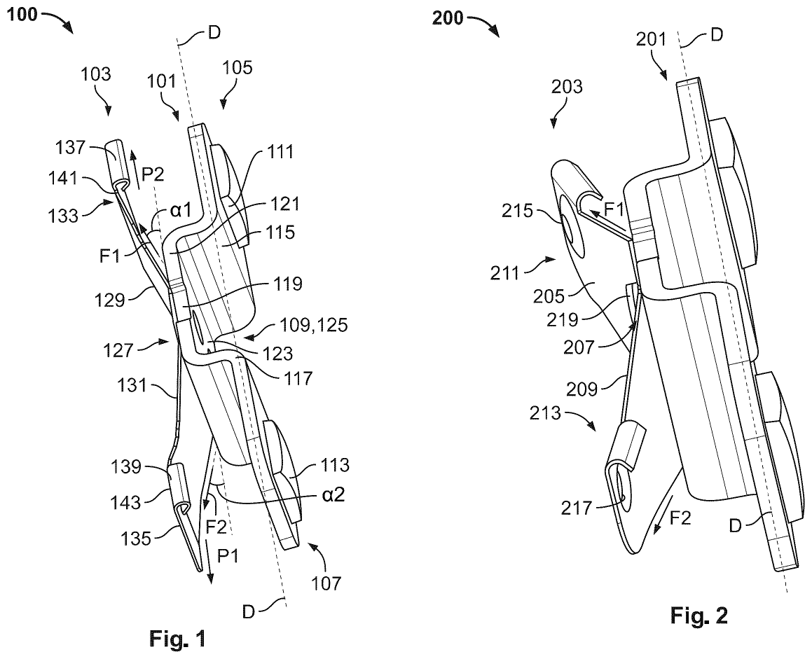

In the following detailed description of embodiments, identical reference signs identified in different figures and/or in different portions of the description of the figures relate to identical elements. Further, unless explicitly mentioned otherwise, the structural features of the objects illustrated in FIGS. 1 to 5 are not drawn to scale.

The technical features and their associated advantages or effects described in the following description of embodiments can be combined with or adapted to any aspects or embodiments of the invention, together or independently, yielding further possible embodiments or aspects of the invention.

An electrical contact bridge according to a first embodiment of the invention will now be described with reference to FIG. 1. The contact bridge 100 of FIG. 1 is an electrical contact bridge for an electric contactor comprising at least two electrical terminals separated by a gap to be electrically bridged to close an electrical circuit.

The contact bridge 100 comprises a bridge element 101 and a spring element, in the form of flat spring 103 in the embodiment of FIG. 1. The bridge element 101 comprises a first contacting portion 105, a second contacting portion 107, and a middle portion 109 between the first contacting portion 105 and the second contacting portion 107. The first contacting portion 105 and the second contacting portion 107 extend along a common contacting plane D, the contacting plane D being a plane of engagement of the contacting portions 105, 107 with a respective one of the at least two electrical terminals of an electric contactor.

In an embodiment, the middle portion 109 is monolithic with the first contacting portion 105 and with the second contacting portion 107 such that the middle portion 109 is arranged directly between the first contacting portion 105 and the second contacting portion 107. In the present embodiment, the middle portion 109 is arranged between the first contacting portion 15 and the second contacting portion 107 with respect to the contacting plane D. As shown in FIG. 1, the middle portion 109 is arranged halfway between the first contacting portion 105 and the second contacting portion 107.

In an embodiment, the bridge element 101 is made of an electrically conducting material, in particular comprising copper.

To further improve the electrical contacting properties with the respective terminals of an electric contactor, as shown in FIG. 1, the first contacting portion 105 can comprise a first contact element 111, and the second contacting portion 107 can comprise a second contact element 113. The contact elements 111, 113 may be made of silver tin-oxide and welded onto a respective contacting portion 105, 107.

In the embodiment shown in FIG. 1, the middle portion 109 is U-shaped and the contacting portions 105, 107 are each attached to a respective extremity 115, 117 of the limbs of the U-shaped middle portion 109. In the shown embodiment, the middle portion 109 is U-shaped in a plane perpendicular to the contacting plane D. The contacting portions 105, 107 and the bottom wall 123 of the middle portion 109 are substantially parallel to each other.

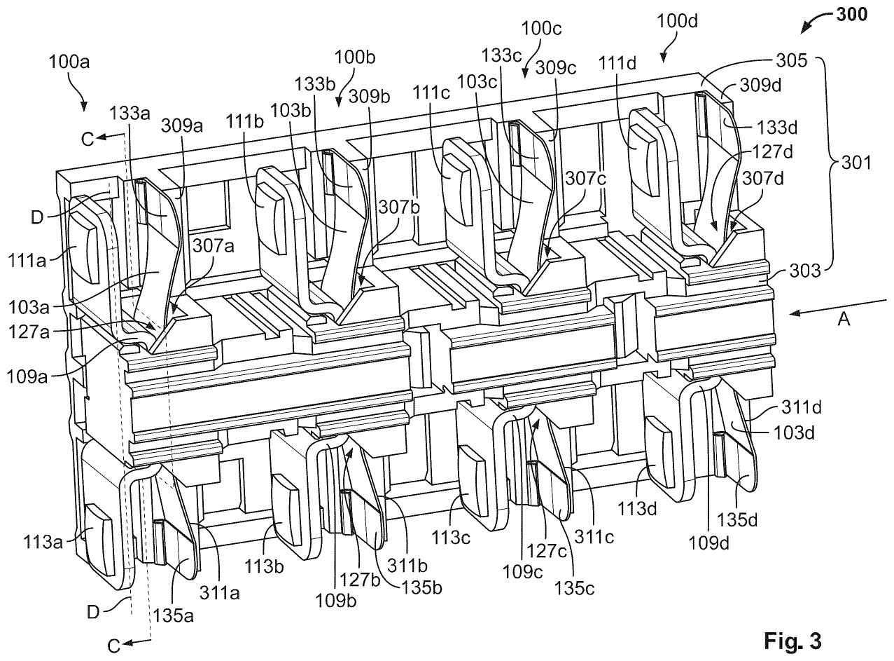

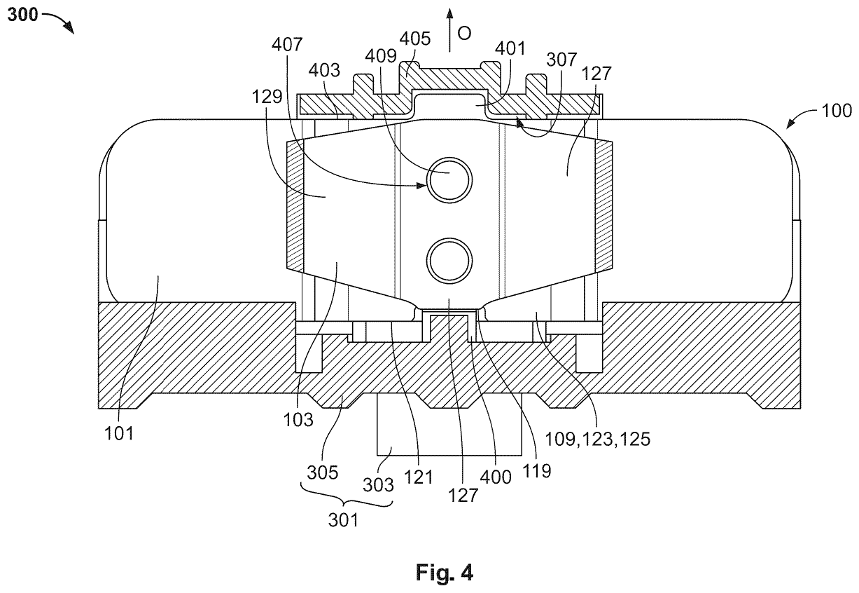

A lateral side 121 of the bottom wall 123 of the U-shaped middle portion 109 comprises a bridge groove 119, as shown in FIG. 1. The bridge groove 119 is configured to receive a matching cam and formed to guide the matching cam along a direction orthogonal to the contacting plane D. The purpose and structure of the bridge groove 119 will be further described in relation to FIGS. 3 to 5. The other lateral side of the bottom wall 123, not visible in FIG. 1, comprises a bridge cam which will be described in FIG. 4.

The U-shape of the middle portion 109 can be a receptacle for receiving a corresponding element, for example a guiding cam, of the movable part. Thus, the electrical contact bridge 200 can be form-fit on the movable part such that it is blocked along at least one direction, in particular a direction parallel to the contacting plane D. In addition, the U-shape can allow for clearance for the electrical contact bridge 200 to adjust its positioning along at least one other direction orthogonal to the contacting plane D.

According to some embodiments, the flat spring 103 can have a U-shape in a plane perpendicular to the contacting plane D. A U-shape can further ensure equal transmission of contact force on to the middle portion 109 of the bridge element 101.

The flat spring 103 is a metal spring element, which can be stamped and bent of a copper-nickel-tin alloy metal sheet. These materials can provide an advantageous balance of tensile strength, cost-efficiency, and durability.

In some aspects of the invention, the bridge element 101 can be based on copper, and the first and/or the second contacting portion 105, 107 can comprise a contact element, such as a contact element made of silver tin-oxide. In this configuration, the bridge element 101 can have improved electrical contact and conduction properties.

The flat spring 103 comprises an attaching portion 127, a first spring arm 129, and a second spring arm 131. The attaching portion 127 is attached to the middle portion 109 by press-fit, using press-fitting bolts and holes not visible on FIG. 1. The press-fit will be further described in relation to FIGS. 3 and 4. The first spring arm 129 extends from the attaching portion 127 in the first direction F1 and the second spring arm 131 extends from the attaching portion 127 in a second direction F2 different from the first direction. In various embodiments, the flat spring 103 can be friction-fit, in particular press-fit, or form-fit, in particular snap-fit, to the middle portion 109. In addition, the attachment may be reversed, improving maintainability and part reusability.

The first direction F1 forms a first angle α1 with the contacting plane D, and the second direction F2 forms a second angle α2, the first and second angles α1, α2 corresponding to the acute angle formed by the intersection of the extension of the respective spring arm 129, 131 with the common contacting plane D. The angles have a same α1, α2 have the same value of less than 60°, less 45°, and less than 20° in various embodiments. In the present embodiment, the angles α1, α2 have a value between 10° and 15°. When the spring arms are thus angled with respect to the contacting plane with smaller angles, the compactness of the contact bridge can be increased.

Each direction F1, F2 of its respective spring am 129, 131 is oriented facing away from the middle portion 109. In the embodiment shown in FIG. 1, the first direction F1 and the second direction F2 are oriented such that the flat spring 103 comprises a U-shape with slanted limbs in the plane orthogonal to the contacting plane D.

The first spring arm 129 comprises a first engagement portion 133 arranged at an end of the first spring arm 129 opposed to the attaching portion 127, and the second spring arm 131 comprises a second engagement portion 135 arranged at an end of the second spring arm 131 opposed to the attaching portion 127. This can ensure additional elasticity of the spring arms 129, 131 with respect to the attached attaching portion 127, when the engagement portions 133, 135 are engaged.

The engagement portions 133, 135 extend parallelly to the contacting plane D, the first engagement portion 133 extending along a direction P1 parallel to the contacting plane D, and the second engagement portion 135 extending along a direction P2 opposed to the direction P1, as shown in FIG. 1. The engagement portions 133, 135 are configured to resiliently engage a movable part of the electric contactor. In particular, the engagement portions 133, 135 extend in the same plane, thus allowing improved mechanical engagement with the movable part of the electric contactor moving in a direction orthogonal to the contacting plane D.

In addition, the first engagement portion 133 comprises a first recurved portion 137 and the second engagement portion 135 comprises a second recurved portion 139. The recurved portions 137, 139 are recurved from the flat spring 103 thin metal sheet towards the bridge element 101. In the shown embodiment, the first recurved portion 137 is provided on a first lateral side 141 of the first engagement portion 133 and extends towards the first contacting portion 105. Similarly, the second recurved portion 139 is provided on a second lateral side 143 of the second engagement portion 135 and extends towards the second contacting portion 107. Their function will be described in greater detail below with respect to FIGS. 3 and 4. The recurved portions 137, 139 can provide resilient abutment of the engagement portions 133, 135 in a corner. It can thus facilitate a fitting of the contact bridge in a moveable part of an electromechanical device and in particular prevent angular displacement of the engagement portions.

FIG. 2 illustrates an electrical contact bridge according to a second embodiment of the invention. The electrical contact bridge 200 shown in FIG. 2 comprises, like the electrical contact bridge 100 of FIG. 1, a bridge element 201 and a flat spring 203. The contact bridge 200 differs from the contact bridge 100 only with respect to the configuration of its flat spring engagement portions. All its other features are identical to the features of the electrical contact bridge 100 described above.

The flat spring 203 comprises a first spring arm 205 extending from an attaching portion 207 in the first direction F1, and a second spring arm 209 extending from the attaching portion 207 in the second direction F2, as shown in FIG. 2. The first spring arm 205 comprises a first engagement portion 211 at an end opposed to the attaching portion 207 and the second spring arm 209 comprises a second engagement portion 213 at an end opposed to the attaching portion 207.

In contrast to the engagement portions 133,135 of the first embodiment illustrated in FIG. 1, the engagement portions to 211, 213 of the second embodiment shown in FIG. 2 extend in the same plane as their respective spring arms 205, 209. That is, the engagement portion 211 extends along the first direction F1, and the second engagement portion 213 extends along the second direction F2. Further, the engagement portions 211, 213 each comprise a respective projection 215, 217. The first projection 215 is a circular embossment in the first engagement portion 211 so as to project outwardly in a direction heading away from the bridge element 201. The projection 217 is also a circular embossment in the second engagement portion 213 so as to project outwardly in a direction heading away from the bridge element 201. The projections 215, 217 reduce surface area of abutment between the respective engagement portions 211, 213 and a mating movable part. Similar or identical projections could also be provided, for example, in the first and/or second engagement portion, 133, 135 of the first embodiment.

Like in the first embodiment, the flat spring 203 is press-fit on the bridge element 201, as will be further described with respect to FIG. 4. In FIG. 2, a press-fitting bolt 219 of the bridge element 201 is visible. The flat spring 203 is press-fit onto the flat spring 203.

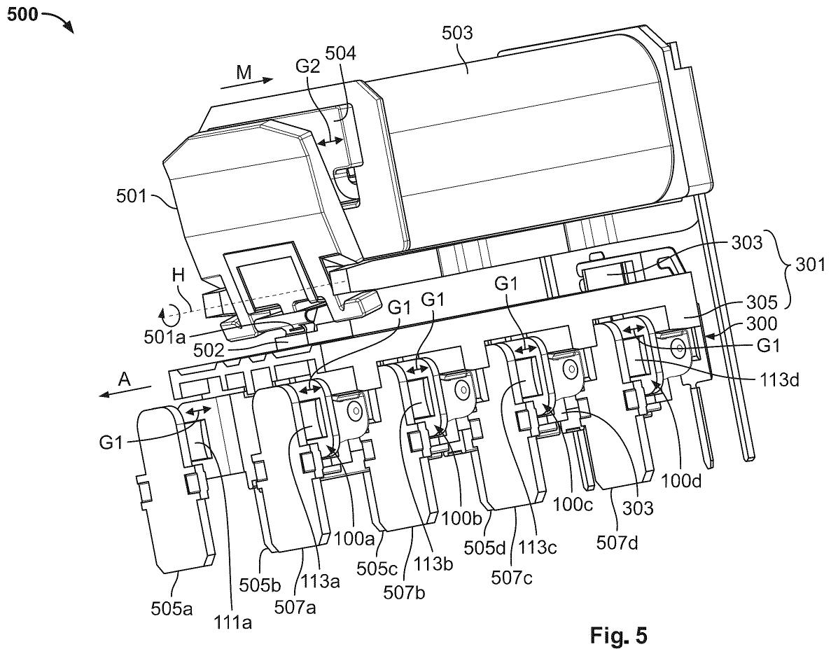

FIG. 3 illustrates a sub-assembly according to a third embodiment of the invention. The sub-assembly 300 shown in FIG. 3 comprises a movable part 301, and four electrical contact bridges 100a, 100b, 100c, 100d identical to the contact bridge 100 described with respect to the first embodiment of the invention. Each contact bridge 100a-100d comprises a respective contact element pair 111a, 113a; 111b, 113b; 111c, 113c; 111d, 113d. The movable part 301 is configured to be moved by an armature of an electric contactor from a first position, in which the contact elements 111a-d, 113a-d do not abut terminals of the electric contactor and an electrical circuit is open, to a second position, in which the contact elements 111a-d, 113a-ddo abut terminals of the electric contactor and an electrical circuit is closed. This will be further described in detail with respect to FIG. 5.

The movable part 301 comprises a first part 303 and a second part 305 that are snap-locked together, with the contact bridges 100a positioned in between the first part 303 and the second part 305. Specifically, each middle portion 109a, 109b, 109c, 109d and the respectively attached attaching porting 127a, 127b, 127c, 127d is installed in a respective cavity 307a, 307b, 307c, 307d of the first part 303, as shown in FIG. 3.

The second part 305 is slid over the first part 303 in a direction S so as to envelop the middle portions 109a-d and the respectively attached attaching portions 127a-d in their respective cavities 307a-d, and snap-locked with the first part 303. The snap-lock mechanism is not visible in FIG. 3.

As shown in FIG. 3, the second part 305 comprises, for each contact bridge 100a-d, a first support portion 309a, 309b, 309c, 309d and a second support portion 311a, 311b, 311c, 311d. In the shown embodiment, each first support portions 309a-d and its matching the second support portions 311a-d extend in a same plane parallel to the contacting plane D. Each contact bridge 100a-d is arranged in its respective cavity 307a-d such that a respective first engagement portion 133a, 133b, 133c, 133d is resiliently engaged with a first support portion 309a-d and a respective second engagement portion 135a, 135b, 135c, 135d is resiliently engaged with a second support portion 311a-d. When the second part 305 is snap-locked with the first part 303, the flat springs 103a, 103b, 103c, 103d of the contact bridges 100a-d are slightly pre-stressed against the support portions 309a-d, 311a-d.

When an external mechanical activation force A, here parallel to the snap-lock direction S, is applied on the movable part 301, the entire subassembly 300 moves, and can be moved for example from a first position to a second position. In an embodiment, when the activation force A is applied on the first part 303, it is transmitted via the support portions 309a-d, 311a-d of the snap-locked second part 305 into the respectively engaged engagement portions 133a-d, 135a-d of the flat springs 103a-d. The arrangement of the spring arms of the flat springs 103a-d concentrates and balances out the activation force A onto the middle portions 109a-d, in particular as the middle portions 109a-d are located in the middle each contact element pair 111a, 113a; 111b, 113b; 111c, 113c; 111d, 113d.

FIG. 4 shows a cross-sectional view of the sub-assembly 300 along the cross-sectional view line C shown in FIG. 3. The view of FIG. 4 shows a contact bridge 100 positioned between the first part 303 and the second part 305 of the movable part 301. Specifically, the middle portion 109 of the bridge element 101 and the respectively attached attaching portion 127 of the flat spring 103 are positioned in a cavity 307 of the first part 303. The second part 305 is slid over the cavity 307 so as to envelop the middle portion 109 and the respectively attached attaching portion 127.

As already described with respect to FIG. 1, the middle portion 109 comprises a bridge groove 119 formed in a lateral side 121 of the bottom wall 123 of the U-shaped recess 125 formed by the middle portion 109. The bridge groove 119 receives a matching cam 400 of the first part 303 of the movable part 301. The bridge groove 119 can guide an elastic movement of the electrical contact bridge when the movable part 301 is moved, for example by activation of a contactor.

As shown in FIG. 4, the middle portion 109 comprises a cam element 401 formed on another lateral side 403, that is opposed to the lateral side 121, of the bottom wall 123 of the U-shaped recess 125. The cam element 401 protrudes from the middle portion 109 in a direction O in the contacting plane P, and orthogonal to the directions F1, F2 of extension of the spring arms 127, 129. The cam element 401 is received in a matching groove 405 of the first part 303 of the movable part 301. The pairing 119, 400 of the bridge groove 119 and the matching cam 400, as well as the pairing 401 between the cam element 401 and the matching groove 405, facilitates micro-movements of the bridge element 101 along the activation direction A in accordance with the elastic bending of the spring arms 127, 129 of the flat spring 103. The cam element 401 may guide an elastic movement of the electrical contact bridge when the movable part is moved, for example by activation of a contactor.

As previously mentioned, the attaching portion 127 of the flat spring 103 is press-fit on the middle portion 109 of the bridge element 101. For this purpose, the attaching portion 127 comprises press-fit holes 407, here two press-fit holes, and the middle portion 109 comprises matching press-fit bolts 409, here two press-fit bolts, such that the press-fit bolts 409 can be press-fit into the press-fit holes 407. In variants of the invention, the attaching portion 127 can also be riveted, welded, or otherwise form-fitted with the middle portion 109.

FIG. 5 illustrates an electro-mechanical device according to a fourth embodiment of the invention. FIG. 5 shows an electric contactor 500 configured for the opening and closing of an electrical circuit in a solar panel installation. In the view of FIG. 5, the contactor 500 is in a first position, in which an electric circuit is in an open state. The electric contactor 500 comprises the sub-assembly 300, a movable armature 501, a magnetic device 503, and a plurality of fixed, or static, electric terminals 505a, 505b, 505c, 505d, 507a, 507b, 507c, 507d. In the shown embodiment, the electric contactor 500 comprises four pairs of a first electric terminal 505a-d and a second electric terminal 507a-d.

For example, when the contactor is configured to switch a three-phase electric circuit, each of the four pairs 505a, 507a; 505b, 507b; 509a, 509b; 511a, 511b of electrical terminals may be arranged in series in, respectively, a first phase line L1, a second phase line L2, a third phase line L3, and a neutral line N. As shown in FIG. 5, the electric terminals 505 are not engaged with respective contact elements 111a-d, 113a-d, but instead separated therefrom by respective gaps G1. The respective three-phase circuit is therefore in an open state.

In an embodiment, the electric contactor 500 can further comprise a housing not shown in FIG. 5 that envelops the electric contactor 500 elements shown in FIG. 5.

The armature 501 is configured as a lever pivotable around a hinge element of the contactor 500 defining a hinge axis H. The hinge element itself is not visible on FIG. 5. The armature has a first end 501a arranged on one side of the hinge axis H, and mechanically connected to the sub-assembly 300. Specifically, the first end 501a is attached to an activation portion 502 of the first part 303 of the movable part 301.

When the electric contactor 500 is activated, for example by external command, the magnetic device 503 generates a magnetic field exerting a magnetic attraction force M on the second end 501b of the armature 501. Thus, the armature 501 is pivoted around the hinge axis H, such that the second end 501b closes a gap G2 with the magnetic device 503 and engages a stopping element 504 of the magnetic device 503. The first end 501a is pivoted around the hinge axis H, applying the activation force A to the first part 301 of the subassembly 300 in a direction opposed to the magnetic force M direction.

The subassembly 300 moves, with the electrical contact bridges 100a-d resiliently engaged against the second part 305, towards the fixed terminals 505a-d, 507a-d of the electric contactor 500 until the contact bridges 100a-d abut against the terminals 505a-d, 507a-d. In the shown embodiment, when the movable part 301 is moved from the first position into the second position, the first contact element 111a-d of a contact bridge 100a-d abuts against a first terminal 505a-d of the electric contactor 500, and a second contact element 113a-d of the contact bridge 100 abuts against a second terminal 507a-d of the electric contactor 500, thus closing the electrical circuit.

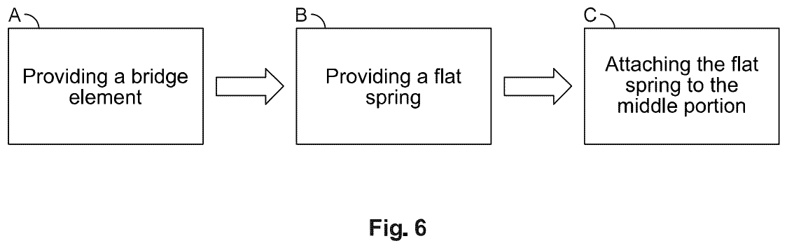

FIG. 6 shows a schematic illustration of a method for manufacturing the electrical contact bridge 100. The method starts with a step A of providing the bridge element 101 comprising the first contacting portion 105, the second contacting portion 107, and the middle portion 109 arranged therebetween. In a step B, the flat spring 103 is provided, comprising the attaching portion 127, the first spring 129, and the second spring arm 131. In a step C, the attaching portion 127 is press-fit to the middle portion 109.

The electrical contact bridges 100 and 200, as well as the sub-assembly 300 and the electric contactor 500, benefit from improved manufacturing cost efficiency and improved contact force distribution when the electric contactor 500 is activated. In an embodiment, the use of a flat spring instead of a coil spring as an overtravel spring provides cost-efficiencies in manufacturing, transport and assembly in a movable part. The flat spring can also offer greater elastic force in a more limited space, offering compactness benefits.

A flat spring is easier to manufacture and more convenient to transport, handle and assemble, than a coil spring. For example, a disentangling of coil springs, which is difficult to automate, is not needed with flat springs. Therefore, manufacturing cost can be reduced. The fixation of the flat spring to a middle portion of the bridge element also allows for a faster assembly and handling of the bridge element and the spring element to the contact bridge.

According to the present invention, the attachment of the flat spring to a middle portion of the bridge element allows concentration of mechanical forces incurred from a contactor activation onto a single, central portion of the bridge element. Thus, the contact force can be advantageously balanced out between two contacting portions, and micro-disparities in the flat spring resulting from manufacturing tolerances can be compensated. The attachment of the flat spring to a middle portion of the bridge element can thus offer improved contact properties in comparison to, for example, an attachment to the first and/or second contacting portion, which may lead to an unbalanced contact force or non-simultaneous contacting of the terminals of the electromechanical device.

According to some aspects of the invention, the first contacting portion and the second contacting portion can extend along a common contacting plane, and the middle portion can be arranged between the first contacting portion and the second contacting portion with respect to the contacting plane. In an embodiment, the middle portion can be arranged half-way between the first contacting portion and the second contacting portion with respect to the contacting plane. According to these configurations, the distribution of the contact force from the spring element to the first and second contacting portions can be even further balanced.

One or more spring arms can allow for a resilient engagement with a movable part of the electromechanical device, for example with a movable part attached to an armature of a contactor, allowing absorption of overtravel or excessive force from the movable part to the bridge element. When the second spring arm extends in a direction substantially opposed to the first direction, the force received by each spring arm can be equalized.

1. An electrical contact bridge for an electromechanical device, comprising:
a bridge element having a first contacting portion engaging a first electrical terminal of the electromechanical device, a second contacting portion engaging a second electrical terminal of the electromechanical device, and a middle portion between the first contacting portion and the second contacting portion; and
a spring element having a flat spring attached to the middle portion.

2. The electrical contact bridge of claim 1, wherein the spring element has an attaching portion attached to the middle portion, a first spring arm extending from the attaching portion in a first direction, and a second spring arm extending from the attaching portion in a second direction different from the first direction.

3. The electrical contact bridge of claim 2, wherein the first contacting portion and the second contacting portion extend along a common contacting plane.

4. The electrical contact bridge of claim 3, wherein the first direction forms a first angle with the common contacting plane and the second direction forms a second angle with the common contacting plane, the first angle and/or the second angle has a value of less than 60°.

5. The electrical contact bridge of claim 3, wherein the first spring arm has a first engagement portion and the second spring arm has a second engagement portion, the first engagement portion and the second engagement portion resiliently engage a movable part of the electromechanical device.

6. The electrical contact bridge of claim 5, wherein the first engagement portion and/or the second engagement portion extends along a direction parallel to the common contacting plane.

7. The electrical contact bridge of claim 5, wherein the first engagement portion and/or the second engagement portion has a recurved portion that is recurved toward the bridge element.

8. The electrical contact bridge of claim 5, wherein the first engagement portion and/or the second engagement portion has a projection that projects in a direction away from the bridge element.

9. The electrical contact bridge of claim 8, wherein the projection is a circular embossment.

10. The electrical contact bridge of claim 3, wherein the middle portion has a U-shaped portion in a plane perpendicular to the common contacting plane.

11. The electrical contact bridge of claim 3, wherein the middle portion has a cam element received in a matching groove of a movable part of the electromechanical device.

12. The electrical contact bridge of claim 11, wherein the cam element protrudes in a direction parallel to the common contacting plane.

13. The electrical contact bridge of claim 12, wherein the cam element protrudes orthogonal to the first direction and/or the second direction.

14. The electrical contact bridge of claim 11, wherein the middle portion has a bridge groove receiving a matching cam of a movable part of the electromechanical device.

15. The electrical contact bridge of claim 14, wherein the bridge groove is arranged in a side of the middle portion opposite a side of the bridge element having the cam element.

16. The electrical contact bridge of claim 1, wherein the flat spring is press-fit or snap-fit to the middle portion.

17. A sub-assembly for an electromechanical device, comprising:
an electrical contact bridge including:
a bridge element having a first contacting portion engaging a first electrical terminal of the electromechanical device, a second contacting portion engaging a second electrical terminal of the electromechanical device, and a middle portion between the first contacting portion and the second contacting portion; and
a spring element having a flat spring attached to the middle portion, the spring element has an attaching portion attached to the middle portion, a first spring arm extending from the attaching portion in a first direction, and a second spring arm extending from the attaching portion in a second direction different from the first direction, the first spring arm has a first engagement portion and the second spring arm has a second engagement portion; and
a movable part including a first support portion and a second support portion, the first engagement portion resiliently engages the first support portion and the second engagement portion resilient engages the second support portion.

18. An electromechanical device, comprising:
a first electrical terminal;
a second electrical terminal; and
a sub-assembly including:
an electrical contact bridge including:
a bridge element having a first contacting portion engaging a first electrical terminal of the electromechanical device, a second contacting portion engaging a second electrical terminal of the electromechanical device, and a middle portion between the first contacting portion and the second contacting portion; and
a spring element having a flat spring attached to the middle portion, the spring element has an attaching portion attached to the middle portion, a first spring arm extending from the attaching portion in a first direction, and a second spring arm extending from the attaching portion in a second direction different from the first direction, the first spring arm has a first engagement portion and the second spring arm has a second engagement portion; and
a movable part including a first support portion and a second support portion, the first engagement portion resiliently engages the first support portion and the second engagement portion resilient engages the second support portion.

19. The electromechanical device of claim 18, further comprising an electromagnetically movable armature attached to the movable part.

20. A method for manufacturing an electrical contact bridge, comprising:
providing a bridge element having a first contacting portion engaging a first electrical terminal, a second contacting portion engaging a second electrical terminal, and a middle portion between the first contacting portion and the second contacting portion;
providing a flat spring having an attaching portion, a first spring arm extending from the attaching portion in a first direction, and a second spring arm extending from the attaching portion in a second direction different from the first direction; and
attaching the attaching portion to the middle portion by press-fitting or form-fitting.
